(19) United States
(12) Patent Application Publication
(10) Pub. No.: US 2021/0015270 A1
(43) Pub. Date: Jan. 21, 2021

(54) Portable Reusable Hygienic Cover for Exercise Equipment

(71) Applicant: RICKY GONZALEZ, MADERA, CA (US)

(72) Inventor: RICKY GONZALEZ, MADERA, CA (US)

(21) Appl. No.: 16/514,349

(22) Filed: Jul. 17, 2019

(51) Int. Cl. A47C 27/14; A63B 26/00

(52) U.S. Cl. CPC A47C 27/14; A63B 26/00

(57) ABSTRACT

A hygienic cover for exercise equipment is disclosed. The invention is comprised of an external, flexible, moisture-resistant covering that encases a cushion material. The hygienic cover fits over a plurality of conventional exercise machines and prevents the user from being exposed to, or transferring perspiration to exercise equipment while operating such machinery. The internal cushion provides extra support to a user when installed on hard equipment surfaces. Straps along the peripheral portions allow it to remain stable during exercise. An object of the invention is to minimize exposure to pathogens commonly found in residual fluids often encountered on exercise machines in humid gym environments.

### CROSS-REFERENCE TO RELATED APPLICATIONS

This application claims the benefit of U.S. Provisional Patent Application No. 62/715,062 filed on Aug. 6, 2018.

### FIELD OF THE INVENTION

The invention relates to exercise equipment. More specifically it relates to a portable, reusable hygienic covering compatible with exercise equipment.

### BACKGROUND

The ancient Greeks were believed to have developed the earliest forms of weight training equipment. One of the first ‘free weights’ used for athletic training were known as halteres (hand-held weights with a hole for gripping). Halteres were used as early as the fifth century B.C. to develop muscular strength for the first Olympics. Illustrations of early Greece show muscular men using dumbbells, weight plates and plummets to train for physical strength. After the development of free weights, it took hundreds of years for a major advancement in resistance training to take place. In the 1950s, American fitness guru Jack LaLanne commercialized several pieces of equipment that have been widely used ever since. LaLanne developed the first cable-pulley machine and the first leg extensions machine. Today, conventional fitness machines are engineered to exercise a wide-array of weight training needs for a many of the major muscle groups in the body. While the health benefits of such machines cannot be overstated, their configurations can include benches, platforms and pads that are often exposed to extreme use. In some gyms, an exercise machine can be used by dozens of athletes each day. Gyms themselves tend to have slightly-elevated levels of humidity depending upon how many patrons happen to be working out. The patrons themselves tend to undergo bouts of perspiration due to the physical demands encountered during machine-based work outs. This combination of elevated humidity combined with available moisture can cause exercise machines to become a breeding ground for pathogens such as bacteria and viruses. While most gyms that offer exercise machines routinely perform best management practices that include repetitive spraying and wipe downs with sanitizers and towels, the potential risk of infection cannot be entirely ruled out. Modern exercise machines that have numerous forms of padding and recesses can place older athletes and those with compromised immune systems at risk of contracting diseases due to the elevated levels of humidity and perspiration usually surrounding such machines.

The fitness industry has come up with ways to combat these risks. United States Patent No. US2010/0178821A1 granted to Morris teaches of a towel with hook and loop straps for exercise equipment but it does not appear to repel moisture. U.S. Pat. No. 9,795,856B2 granted to Scilus disclosed removable absorbent covers for exercise bikes but it does not appear to be transferable to other forms of exercise equipment. U.S. Pat. No. 8,852,712B1 granted to Diaz disclosed a covering for exercise benches, however it does not appear to be moisture resistant. U.S. Pat. Nos. 4,165,555, 4,403,366, 4,448,560, 4,885,195, 6,220,997, 7,322,068, and 7,955,683 granted to Boxer, Lucke, Monaco, Change, Kohl, Kim, and Ferrell respectively all disclosed permeable, towel-like coverings for exercise equipment; however, they too do not appear to repel moisture.

### SUMMARY OF THE INVENTION

The device herein disclosed and described provides a solution to the shortcomings in the prior art through the disclosure of a hygienic covering for exercise equipment. An object of the invention is to prevent a user from coming in contact with potentially-contaminated exercise equipment surfaces. The invention is comprised of a strong, flexible covering that prevents a user from coming in contact with benches and equipment stations.

Another object of the invention is to provide a means to repel moisture. The exterior substrate of the hygienic cover is made of a vinyl material that repels fluids. This feature prevents moisture from being transferred both to and from a user while using exercise equipment.

Another object of the invention is to provide support while using exercise machines. The hygienic cover contains foam pads that are positioned inside each panel providing users with extra cushion and support while working out on exercise machines.

Another object of the invention is to provide a means to secure the hygienic cover to exercise machines. The cover is equipped with straps that can be wrapped around contact areas of a machine. Each strap is affixed with a securement portion to allow the cover to remain in position during strenuous activities.

Another object of the invention is to provide a means to easily transport the hygienic cover. The cover is comprised of a multitude of folding panels that allow the cover to be compacted for easy transport and storage.

Another object of the invention is to provide a means to carry the hygienic cover. The aforementioned straps can be connected in such a manner as to form a set of carry handles.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a top view of the hygienic cover.

FIG. 2 shows a top view of the hygienic cover folded up.

FIG. 3 shows a top perspective view of the hygienic cover folded up.

FIG. 4 shows a side view of the hygienic cover being used.

FIG. 5 shows a perspective view of the hygienic cover installed on a pull down machine.

FIG. 6 shows a perspective view of the hygienic cover installed on a bench press.

FIG. 7 shows a section view of the hygienic cover.

FIG. 8 shows a perspective view of the hygienic cover installed on a leg machine.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

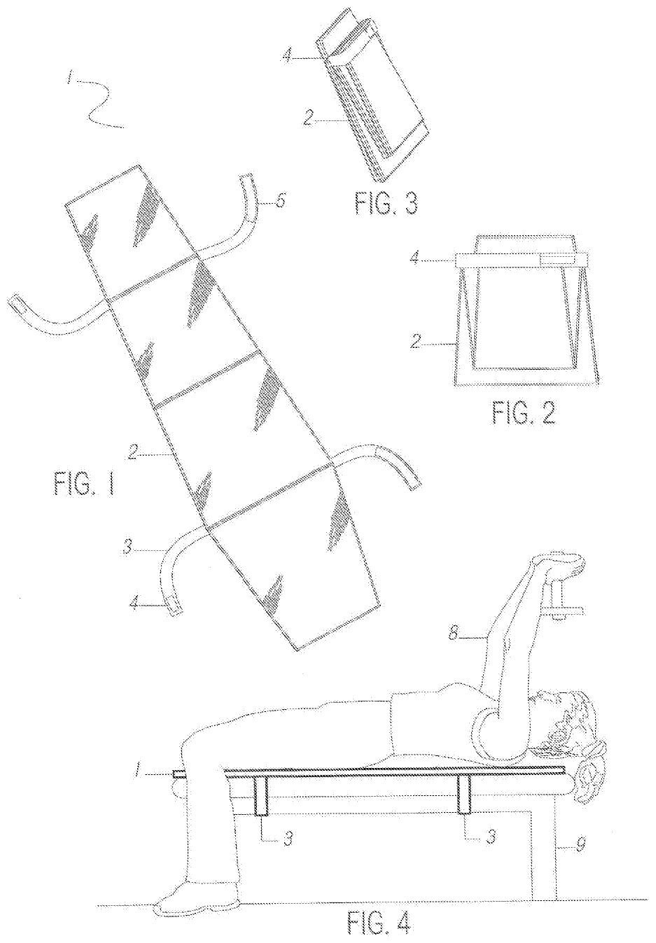

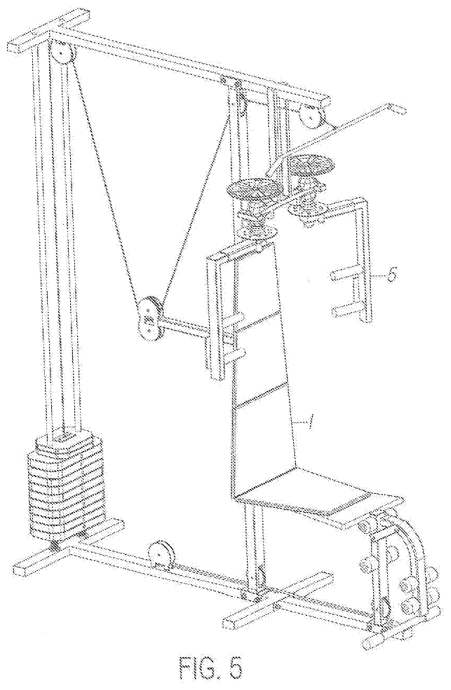

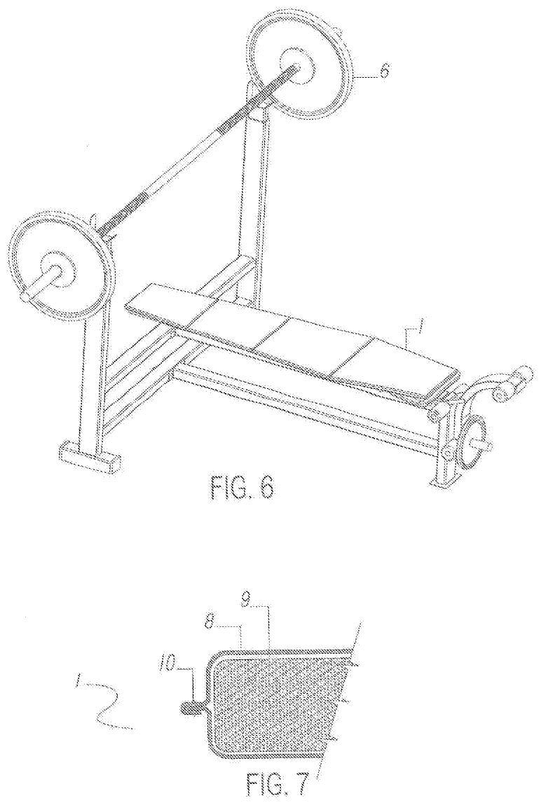

FIG. 1 shows a top view of an embodiment of the invention 1 extended in a planar position. The invention being comprised of at least, but not limited to, four trapezoidal-shaped panels 2. Each said panel 2 having distal ends being foldably-connected there together. Invention 1 also including, but not limited to, at least four straps 3 comprised of a flexible material such as, but not limited to, nylon webbing and the like. Said straps 3 having a means of securement including, but not limited to hook and loop connectors, buckles, snaps etc. FIGS. 2 and 3 showing the invention folded up and ready for transport or storage. FIG. 4 showing an embodiment of the invention 1 disposed between a user 8 and a bench 9. FIGS. 5, 6 and 8 illustrating embodiments of the invention 1 installed on a pull-down machine 5, bench press 6 and leg machine 7 respectively.

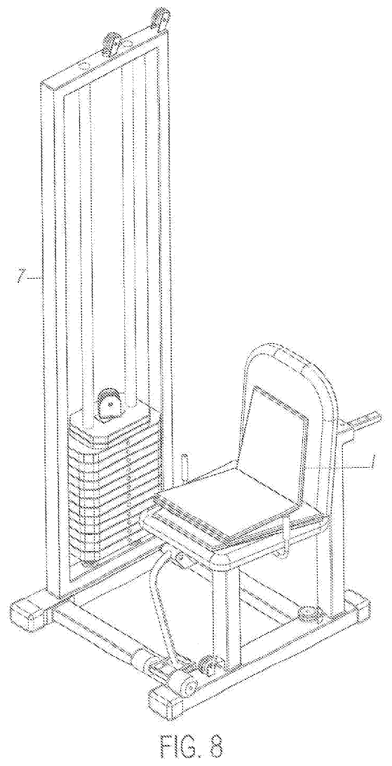

FIG. 7 shows a section view of an embodiment of the invention's external cover 8 comprised of a flexible, moisture-resistant material including but not limited to vinyl, rubber, plastic and the like and being sewn together with a thread 10 comprised of a material such as but not limited to nylon, monofilament etc. Said external cover 8 also being configured to receive a planar-shaped internal cushion 9. The aforementioned internal cushion 9 being comprised of a firm, sponge-like material such as high-density foam, doll cotton and the like.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A hygienic mat comprised of the following parts:
(a) an external covering;
(b) a plurality of internal cushions; and
(c) a multitude of straps.

2. The multitude of straps of claim 1 having securement portions thereon.

2. A method for hygiene, the method being comprised of:
(a) fitting on a plurality of exercise equipment;
(b) selectively anchoring to exercise equipment;
(c) preventing a user from being exposed to moisture from exercise equipment;
(d) preventing a user from transferring perspiration to exercise equipment;
(e) providing cushion support; and
(f) folding together for transport and storage.

3. The method of preventing a user from being exposed to moisture in claim 2, wherein a user also being protected from pathogens that may reside in said moisture.

4. The method of preventing a user from transferring perspiration to exercise equipment in claim 2, wherein a user also being prevented from transferring pathogens that may reside in said perspiration.
